(19) United States
(12) Patent Application Publication
(10) Pub. No.: US 2005/0008850 A1
(43) Pub. Date: Jan. 13, 2005

(54) Glass flake having high thermal conductivity

(75) Inventors: Ronald T. Flynn, Blacklick, OH (US); Darryl A. Payne, Granville, OH (US); Ralph E. Brandon, Newark, OH (US)

Correspondence Address: PEARNE & GORDON LLP, 1801 EAST 9TH STREET, SUITE 1200, CLEVELAND, OH, 44114-3108, US

(73) Assignee: Electrolock, Inc., Hiram, OH (US)

(21) Appl. No.: 10/877,074

(22) Filed: Jun. 25, 2004

Related U.S. Application Data
(63) Continuation-in-part of application No. 10/154,499, filed on May 24, 2002, now Pat. No. 6,773,793.

(51) Int. Cl. B32B 5/16; B32B 27/34

(52) U.S. Cl. 428/331; 428/430; 428/435

(57) ABSTRACT

The present invention relates to a glass flake material having high thermal conductivity. The glass flake material can be used in the manufacture of insulating materials for electrical insulation applications, and, more specifically, relates to a sheet material having high thermal conductivity. The use of the glass flake in the sheet material can be used to enhance the thermal conductivity of high voltage ground walls in large motor coils and generator coils for example.

### CONTINUATION DATA

This application is a continuation-in-part of U.S. application Ser. No. 10/154,499, filed May 24, 2002.

### FIELD OF THE INVENTION

The present invention relates to a glass flake material having high thermal conductivity. The glass flake material can be used in the manufacture of insulating materials for electrical insulation applications, and, more specifically, relates to a sheet material having high thermal conductivity. The use of the glass flake in the sheet material can be used to enhance the thermal conductivity of high voltage ground walls in large motor coils and generator coils for example.

### BACKGROUND OF THE INVENTION

Glass flakes have been commercially available since the 1950's when they were introduced by the Owens Corning Fiberglass Corporation. At the time, they were viewed as an alternate product form to glass fibers, which had been introduced about fifteen years earlier by the same company. While there are some obvious similarities between glass fibers and glass flakes (e.g. chemical composition) their dramatically different form means that the performance they impart to polymers will be quite different. Since glass flakes are shattered pieces of what was once a very thin sheet of glass, they are highly angular and planar glass particles that are commercially offered in thicknesses centered from two microns to thicknesses centered at approximately six microns. The particle sizes offered are driven by the end use applications and can range from a few tens of microns to several thousand microns.

Due to the physical form of the flakes, they offer some unique advantages over glass fibers and other fillers. For example, compared to fibers, flakes behave isotropically (at least in two dimensions) and thus offer much better shrinkage control in polymer matrices. Since glass flakes are a synthetic product, they can be designed to offer unique properties compared to other platy fillers (e.g. mica). The design flexibility offered by the glass flake manufacturing process means that the potential range of glass flake products is quite large. This is evident by the emerging applications and further evidenced by the diversity of glass fiber products, which enjoy the same design flexibility as do flakes by virtue of their similar manufacturing process.

Insulated electrical coils for conventional electrical machines have been produced for many years with an electrical insulation tape made of a glass cloth bonded to a laminated mica paper. This tape is wound around a coil conductor and is typically impregnated with a thermosetting resin and cured. In the alternative, the tape may be a semi-cured (e.g. “b-stage”) prepregnated tape which is wound around the coil and then cured.

The dielectric strength of such conventional tapes is mainly derived from the mica, and the mechanical strength of the tape is largely due to the glass cloth. However, because the dielectric strength of the mica utilized in such tapes is relatively low, the dielectric resistance and resulting insulating properties of such conventional tapes has not always proved satisfactory in electrical applications.

Many avenues have been investigated to improve the insulating properties of insulating papers and resulting tapes produces therefrom. Much of the investigation has focused on improving the thermal conductivity of the resins used in the formation of the insulating tapes. A more recent investigation in U.S. Pat. No. 5,691,058 focused on the use of glass flake made by using a sol-gel process wherein the glass flake has a thickness of 0.2-1 μm and a diameter of 40-250 μm.

Traditionally, conventional glass flakes are made by a number of well-known processes. These include crushing hollow glass spheres, casting thin sheets from sol-gel solutions (and, subsequent firing), centrifugally spinning glass, melt drawing tubes, etc. While the actual commercial significance of these methods in unknown, it seems clear that the majority of commercially available glass flakes have been made via a melt drawing technique. This process, which is quite similar to a reinforcement type fiberglass production process, involves the mechanical drawing or attenuation of a tube of glass to a desired thickness and then the subsequent grinding and classifying of the product. In some cases, this ground product then receives a chemical treatment to enhance a particular property (e.g. adhesion). The glass flakes produced by such conventional processes have a flake size of approximately 5 μm in thickness and a diameter of approximately 200-400 μm.

Accordingly, it would be advantageous to produce a sheet material for electrical insulation which has enhanced thermal conductivity compared to conventional sheet materials thereby improving the insulating properties of articles (i.e. insulating tapes) made therefrom.

### SUMMARY OF INVENTION

In accordance with one aspect of the invention, a glass flake material having high thermal conductivity is provided.

An additional aspect of the invention is to provide a sheet or paper made from glass flake wherein the sheet or paper has a high thermal conductivity.

Another aspect of the invention is to provide an insulating tape made from glass flake sheets or paper wherein the insulating tape has an high thermal conductivity.

A further aspect of the invention is to provide an a method for improving the thermal conductivity of insulating tape containing mica by replacing a portion of, or all of, (>0% to 100%) the mica with glass flake.

Another aspect of the invention is to provide a method for increasing the power output of electrical equipment by insulating the electrical equipment with insulating tape made from glass flake.

A further aspect of the invention is to provide a cost savings to large generator manufacturers by enabling them to produce air cooled generators in a size that typically calls for water cooled generators thus providing a cost savings in the millions of dollars per generator.

These and other aspects and features of the invention are set forth below in the detailed description.

### DETAILED DESCRIPTION OF THE EMBODIMENTS

As used herein and in the claims, all percentages are given as weight percentages unless otherwise indicated. As used herein and in the claims, all weight percentages are percentages of the total weight of the electrical sheet material.

Glass flake has a thermal conductivity of from about 1.0 W/m° K. (for D-glass) to about 1.4 W/m° K. for C and E glass flake. D-glass flake has a lower dielectric constant than mica along with a higher thermal conductivity (mica has a thermal conductivity of about 0.6 W/m° K.) and therefore will provide superior performance as an insulating sheet. While C and E glass have dielectric constants that are about the same as mica, the thermal conductivity of these glass flakes is significantly higher than that of mica thereby contributing to their overall superiority over mica when used in electrical insulation applications. Unlike mica, however, glass flake has no self-bonding characteristics. As a result, additive components are utilized in the insulation products (such as sheets and tapes) made from the glass flake to provide for the physical integrity of the products during manufacture and use. Advantages achieved from the incorporation of additives into glass flake electrical insulation products include, but are not limited to: 1) improved retention of the glass flake during manufacture, 2) improved wet handling of the glass flake sheet during manufacture, 3) porosity control, 4) bonding of the glass flake into insulating sheets for improved dry flake retention and sheet strength, and 5) reinforcement of insulating sheets for improved physical strength.

The present invention embodies at least two forms which are similar but distinct. The first form of the invention is an insulating sheet in which the majority of the physical strength is provided by a fabric or unidirectional continuous reinforcing yarns. The second form is an insulating sheet wherein discrete fibers are intermingled with the glass flake to provide for the physical integrity of the sheet. The aforementioned sheets are respectively referred to herein “reinforced” and “un-backed” insulating sheets.

The electrical insulating sheet material of the present invention has the following preferred formulations or tables of components, depending on whether it is the “reinforced” or the “un-backed” form. In these formulations or tables of components, any preferred or less preferred weight percent or weight percent range of any component can be combined with any preferred or less preferred weight percent or weight percent range of any of the other components; it is not required or necessary that all or any of the weight percents or weight percent range come from the same column.

TABLE OF COMPONENTS FOR A BACKED INSULATING
SHEET (EXCLUDING CONTINUOUS REINFORCING
YARNS)

| | WEIGHT PERCENTS | | |
|---|---|---|---|
| | Less Preferred | Less Preferred | Preferred |
| Glass flake (C, D, E) | 50-99 | 70-95 | 80-95 |
| Retention Aid/Porosity | 0-45 | 0-10 | 0-3 |
| Control Agent | | | |
| Bonding Agent | 0-30 | 5-17 | 5-12 |
| Discrete Fiber | 0-20 | 0-7 | 0-5 |

TABLE OF COMPONENTS FOR A UN-BACKED
INSULATING SHEET

| | WEIGHT PERCENTS | | |
|---|---|---|---|
| | Less Preferred | Less Preferred | Preferred |
| Glass flake (C, D, E) | 50-99 | 70-95 | 80-90 |
| Retention Aid/Porosity | 0-45 | 0-10 | 0-3 |
| Control Agent | | | |
| Bonding Agent | 0-30 | 5-25 | 5-15 |
| Discrete Fiber | 0-20 | 5-15 | 7-12 |

The additives used in glass flake insulating sheet according to the invention constitute the following broad categories:
retention aids
porosity control agents
bonding agents
reinforcements

In some cases, an additive may fit in more than one category.

Retention aids help capture the finer flake particles during the wet-forming of the insulating sheet. They also help retain the flake by mechanical entrapment in the dry, finished sheet. Examples of retention aids are fibrids, flocs or synthetic pulps.

Porosity control agents disrupt the planarity of glass flake particles creating channels for the absorption of saturating resins. It should be understood that the porosity of the insulating sheet needs to be controlled in that too porous of a structure could lead to voids in the finished electrical component while too closed of a structure will be hard to saturate. Porosity control agents need to be thermally stable to the conditions used during manufacture and saturation of the insulating sheets. Examples of porosity control agents are fibrids and cylindrical fine fiber flocs produced from continuous fiber filaments.

Bonding agents are used to bond the glass flake together and to provide improved mechanical strength to the insulating sheet. The bonding agent can be either a thermoplastic or thermoset resin. The thermoplastic can be solid fusible particle, fiber, floc or an aqueous dispersion of a thermoplastic resin. It is important that the thermoplastic bonding agent needs to flow and bond at lower temperatures and pressures than the materials used as porosity control agents and reinforcing agents. Thermoset bonding agents will be aqueous dispersions of the uncured resin or a particulate b-staged form of the resin. Examples of thermoplastic bonding agents are low softening point flocs or binder fibers such as polyolefin floc. Examples of thermoset bonding agents are aqueous dispersions of epoxy or urethane resins.

Reinforcements can be of two types. The first type encompasses fabrics and continuous yarns which can be incorporated into the insulating sheet during sheet manufacture or as a post manufacture lamination step. These fabrics and yarns run continuously along the length of the insulating sheet. As with the porosity control agents, reinforcing agents need to be thermally stable, i.e. not stretch or shrink, under the thermal conditions encountered during manufacture or application of the insulating sheet. Some examples of scrims and continuous yarns that can be are polyaramid, E-glass, D-glass, polyimide, and polyester.

The second type of reinforcement is the use of discrete, dispersible fibers which form a random array within the insulating sheet and are bonded into the insulating sheet by a bonding agent. Examples of suitable discrete fibers are polyaramid, E-glass, D-glass, polyester, and nylon.

An embodiment of the invention is an electrical insulating sheet material (or “glass flake paper”) the primary component of which is C, D or E-glass flake. The glass flake useable in the insulation sheets of the present invention have approximately the following compositions in weight percent:

| Oxide | C-Glass | D-Glass | E-Glass |
|---|---|---|---|
| SiO₂ | 64-68 | 72-75 | 52-56 |
| Al₂O₃ | 3-5 | 0-1 | 12-16 |
| B₂O₃ | 4-6 | 21-24 | 5-10 |
| CaO | 11-15 | 0-1 | 16-25 |
| MgO | 2-4 | | 0-5 |
| BaO | 0-1 | | |
| Na₂O + K₂O | 7-10 | 0-4 | 0-2 |
| TiO₂ | | | 0-1.5 |
| Fe₂O₃ | 0-0.8 | 0-0.3 | 0-0.8 |
| F₂ | | | 0-1 |

As mentioned previously, glass flakes may be produced in several ways, for example a melt drawing process. In melt drawing, the glass raw materials are heated to a temperature which is typically in excess of 2000° F., and more typically around 2650° F., at which point the molten glass exhibits a viscosity of approximately 750-1000 poise. The molten glass is then extruded from the melting apparatus and mechanically attenuated through a die (typically made from a precious metal or metal alloy, such as platinum or platinum containing alloy, due to high temperatures present in the extrusion process) to form a long thin tube. By adjusting the rate of extrusion and speed of attenuation, the thickness of the tube walls can be controlled. The thickness of the tube walls corresponds to the thickness of the glass flakes produced in the process. This thickness should be between about 1 micron to about 12 microns, tending more generally between about 3 to about 10 microns, more preferably between about 4 to about 7 microns and most preferably about at least 5 microns. The tube is broken off as it cools and separates from the attenuation device. Subsequently, the pieces of the glass tube are ground, for example, in a ball mill. The ground flakes generally are put through a series of vibratory screens to obtain flakes of the desired particle size distribution. The preferred diameter of the flakes is typically from about 200 to about 400 microns. This flake diameter is similar to the flake size of uncalcined muscovite mica currently used in conventional insulation sheets.

In one example, the insulating sheet material according to the invention further comprises retention/porosity control agents in the form of fibrids, such as poly [1,3-phenylene isophthalamide] fibrids. Poly[1,3-phenylene isophthalamide] fibrids are available under the trade name NOMEX® from DuPont. Fibrids generally refer to particles of material in which one of the dimensions is several orders of magnitude smaller than the other two dimensions. A fibrid is thus similar to a flake. Suitable fibrids have a thickness of approximately 1-10 micrometers, with a width and length each of approximately 100-1000 micrometers. While NOMEX® fibrids are suitable for use in an embodiment of the invention, other fibrids having dielectric strength as good as or better than glass flake, i.e. <3.6 dielectric constant of D-glass [measured at 21° C. and 106 Hz], may be used, provided that they are thermostable at the conditions used during manufacture and fabrication of the insulating sheet, e.g. 150° to 250° F. and 40 to 80 psi typical of the hot calendaring conditions of temperature and pressure required to fuse the thermoplastic resin when a polyolefin is used as a bonding compound (as set forth below).

In another example, the insulating sheet material according to the invention further comprises retention/porosity control agents in the form of floc, such as the polyaramid Poly [1,4-phenylene isophthalamide] floc. Poly [1,4-phehylene isophthalamide] flocs are available under the trade name KEVLAR® from DuPont. In this context, flocs refer to fine, split or branched fibers or micro fibers (fibrils) similar in appearance to fibrulated wood pulp. While KEVLAR® floc is suitable for use in an embodiment of the invention, other flocs having similar high dielectric properties may be used, provided that they are thermostable at typical hot calendaring conditions (e.g. 40 to 80 psi, 150 to 250° F.) of temperature and pressure required to fuse the thermoplastic resin used as a bonding compound (as set forth below).

The use of the above fibrids and/or flocs in addition to the glass flakes enhances the porosity and wetting characteristics of the final product, helps to retain the glass flakes during manufacture by collecting and holding the glass flakes, and increases the wet strength of the unbonded sheet through mechanical interlocking or entanglement to reduce tearing during processing prior to the final bonding step. Finally, the fibrids and/or floc enhance the mechanical strength of the finished electrical insulating sheet material without unduly compromising its dielectric strength. The floc and/or fibrids typically make up less than 10% of the weight of the glass flake paper.

The insulating sheet material according to the invention may further comprise a bonding agent or binder resin, typically a thermoplastic and/or thermoset resin. A thermoplastic resin may be introduced into the sheet in the form of a floc such as polypropylene or polyethylene. Floc is made up of fine fibrils that are nonlinear and contain splits and/or branches. The floc fibrils, which act as a retention aid in addition to being a bonding agent, must be fine enough to provide even distribution and uniform bonding when the sheet is calendared. Other thermoplastic resins may be used, provided that they have a flow temperature sufficiently lower than the temperature at which the porosity control agents melt or degrade. In addition to the above, an optional resin accelerator, such as zinc, may also be included. The amount of the binder resin included is relatively small such as, for example, about 7% by weight. The resin accelerator can be present in a small amount such as, for example, about 1% by weight.

Thermoset bonding agents can also be used as a bonding agent. Typically, the same epoxy saturants used in mica based insulating sheets can be used either as aqueous dispersions applied to the wet formed sheet and then dried to the “b-stage” or else applied as non-aqueous systems to the previously dried glass flake paper and then cured to the b-stage. It is preferred, but not required, that the b-stage curing take place in a double belt press so the glass flake insulating sheet is taken to the b-stage in a compacted state.

During production, the insulating sheet is dried and then subjected to a heat treatment above the bonding resin's fusion/cure temperature. These operations can be accomplished in several ways. Drying can be accomplished by passing the wet sheet over conventional can dryers or through an air-through oven. The fusing operation can be accomplished in three ways.

1. The insulating sheet can be consolidated and fused or cured by passage through a hot calendar at a temperature and pressure appropriate for the bonding resin. For example, utilizing a single nip laminating calendar and a polyolefin floc bonding agent a temperature of 180° to 210° F. and a pressure of 40 to 80 psi would be appropriate.

2. The bonding agent can be raised to its flow or cure temperature in an air-through oven as the final step in the drying operation. If a thermoset resin is used, this technique precludes further consolidation.

3. The dried insulating sheet can be consolidated and fused or cured by passage through a double belt press using temperatures and pressures appropriate for the bonding resin. In the case of thermoplastic bonding agents, a double belt press equipped with a cooling zone is preferred. As an example, with a polyolefin floc bonding agent consolidation and fusing occurs at a temperature of 285° F. and a pressure of 60 psi.

In an example embodiment of the invention, the insulating sheet material can be reinforced by incorporating discrete fibers. Suitable materials for the fibers include poly [1,3-phenyleneisophthalimide] (available from DuPont under the trade name NOMEX®) and poly [1,4-phenyleneisophthalamide] (available from DuPont under the trade name KEVLAR®), E-glass and D-glass (which is more expensive). Other possible fiber materials include other materials that have good dielectric properties and are thermostable under the hot calendaring conditions described above. The fibers should be 0.1-1.0 inches in length, more typically 0.3-0.6 inches. Organic fibers should have a diameter of 10 to 20 microns and preferably 14 to 15 microns. Glass fibers should have diameter of 6 to 11 microns preferably 7 to 8 microns.

In another example, embodiment of the invention unidirectional continuous yarn reinforcements can be incorporated into the insulating sheet. The preferred materials for these continuous reinforcements are the same as for discrete fiber reinforcements. The continuous yarn reinforcements can take the form of a scrim, open fabric or multiple unidirectional yarns inserted in the machine direction of the insulation sheet. It will be understood by those familiar with the art that many scrims or open face fabrics are available with various cost/performance points. A fabric that has proven useful but not necessarily optimum is an E-glass fabric style 1070 available commercially from Burlington Glass Fabrics (BGF). The fabric/scrim can be introduced during the manufacture of the insulating sheet or laminated to an already formed sheet in a post formation laminating step preferably in conjunction with the consolidation fusing operation. Alternately, a plurality of parallel yarns can be injected into the forming zone of the paper machine during the formation of the insulating sheet. The spacing of the continuous yarns is dependent on the ultimate strength of the yarn, the width of tape to be cut from the insulating sheet, and the strength requirements for the tape. As an example, D-900 E-glass yarn incorporated into the sheet at ½″ intervals would produce an acceptable insulating sheet.

To prepare the insulating sheet material, the C, D or E-glass flake and selected additives, e.g. fibrids, floc, and fibers, are mixed with water to produce a dilute slurry. The slurry may then be processed through a standard flat wire Fourdrinier machines, inclined wire Fourdrinier machine or other suitable papermaking machine to form the sheet. The formed sheet is then dried on conventional can dryers or by passage through an air-through oven. The dried sheet is then consolidated and fused or cured in an in-line or off-line operation as described previously. The insulating sheet material is generally created as a continuous sheet and stored as a roll.

The insulating sheet of the invention typically will have a density lower than that of a comparable sheet prepared from mica. In one embodiment, the density of the glass flake insulation sheet is preferably at least about 1.60 g/cc.

If the insulating sheet includes discrete fibers as described above, then the sheet will generally be finished when it emerges from the papermaking machine and consolidation/fuse/cure operation. If the insulating sheet does not include the discrete fibers, then the sheet will be reinforced with continuous yarns in the form of a fabric/scrim or a plurality of continuous yarns. The continuous yarn reinforcement provides additional tensile strength to the insulating sheet for subsequent winding onto an electrical component. The reinforcement/backing may be added to the insulating sheet either in the papermaking machine or in a separate step after the sheet emerges from the machine. If added during sheet formation, the continuous reinforcement provides wet strength to the sheet, which enhances processability. While the reinforcement backing is generally used with the fiber-less insulating sheet, the fiberglass backing may of course be used with the fiber-containing sheet if additional tensile strength is required.

In another embodiment of the invention, the insulating sheet does not contain the fibers or the floc. This embodiment comprises the C, D or E-glass flake and the fibrids as described above. While this embodiment has good dielectric properties, its tensile strength and wet strength are low.

In another embodiment of the invention, the insulating sheet does not contain the fibers or the fibrids. This embodiment comprises the glass flake and the floc as described above. While this embodiment has good dielectric properties, its tensile strength and porosity is low. The lowered porosity results in an insulating sheet which is harder to saturate.

The following examples are provided to illustrate the practical aspects of the invention and are not intended to limit the invention in any way.

### EXAMPLES

Three runs of D-glass Flake Paper were produced for testing. The paper was made up of:
93.65% D-glass flake (sieve distribution −80, +200 mesh)
1.4% Nomex® Fibrids
2.2% EST 8 polyolefin floc
2.75% ½″×2 dpf Nomex® fibers

The dielectric constant and dissipation factor of the glass flake paper was measured and compared against three samples of KM160XL Mica Paper, available from Isola-Volta. Three 3.0″×3.0″ samples of each were tested. The samples were tested in a test cell using two different test fluids. The test specimens were conditioned for 40 hours at laboratory ambient temperature. The test cell was filled with the first fluid to approximately 90% capacity. Using clean tweezers, the specimen to be tested was carefully inserted between the plates of the test cell, and the test cell was then placed in a vacuum chamber for 5 minutes to remove any trapped air.

After removal from the vacuum chamber, leads were then plugged into connectors in the cell to create a test circuit, and the test circuit was tuned. The capacitance of the liquid cell with the specimen, as well as the dissipation factor of the fluid with specimen, were determined. The specimen was removed and the capacitance and the dissipation factor of the liquid alone was recorded. The procedure above was followed for the second fluid.

The Dielectric Constant was calculated using the following formula:

$$Dielectric Constant = \frac{{K}_{x} = {K}_{3} {K}_{2} {C}_{2} {C}_{2 x} {ΔC}_{3} - {K}_{3} {K}_{2} {C}_{3} {C}_{3 x} {ΔC}_{3}}{{K}_{3} {C}_{2} {C}_{2 x} {ΔC}_{3} - {K}_{2} {C}_{3} {C}_{3 x} {ΔC}_{2}}$$

Where:
Kₓ=Dielectric Constant of specimen
K₂=Dielectric Constant of first liquid
K₃=Dielectric Constant of second liquid
ΔC₂=the change in capacitance on insertion of the specimen into the first liquid
ΔC₃=the change in capacitance on insertion of the specimen into the second liquid
C₂ₓ=the measured capacitance of the first liquid
C₃ₓ=the measured capacitance of the second liquid

The test equipment used complied with the calibration test procedures of ISO 10012-1, ANSI/NCSL Z540-1-1994, and MIL-STD-45662A, and the data reported is accurate within the tolerance limitation of the equipment used.

The measured results were as follows:

| Material | Dielectric Constant | Dissipation Factor |
|---|---|---|
| D-Glass Flake Paper | | |
| Sample 1 | 2.72 | 0.0013 |
| Sample 2 | 2.78 | 0.0013 |
| Sample 3 | 2.71 | 0.0014 |
| Average | 2.74 | 0.0013 |
| KM160XL Mica Paper | | |
| Sample 1 | 3.56 | 0.0024 |
| Sample 2 | 3.66 | 0.0015 |
| Sample 3 | 3.50 | 0.0020 |
| Average | 3.57 | 0.0020 |

Thermal Conductivity

A comparative test was conducted wherein the thermal conductivity of simulated high voltage ground wall of mica paper and epoxy resin (sample 1) was compared to the thermal conductivity of a simulated high voltage ground wall of D-glass and epoxy resin. The samples were prepared by hand dipping sheets of the flake paper n epoxy resin, stacking them and curing them in a platen press. Testing was conducted according to specifications set forth in ASTM E1530 Test Method using a Unitherm™ Model 2021.

Thermal Conductivity Tests

| Sample | | | | | | | Temp | |
|---|---|---|---|---|---|---|---|---|
| No. | Material | Dia | Thickness | grams | cc | g/cc | (° C.) | λ(W/m * K) |
| 1 | mica | 2.001 | 0.103 | 11.47 | 5.3082 | 2.16 | 157.1 | 0.309 |
| 2 | D-glass | 2.002 | 0.130 | 11.10 | 6.7064 | 1.66 | 156.8 | 0.347 |

As can be seen from the comparative test above, Sample 2, prepared from D-glass flake, has a much higher thermal conductivity (λ) than Sample 1 which was prepared from mica flake. This is unexpected, especially in view of the lower gram density of the D-glass flake sample (1.66 g/cc) compared to the gram density of the mica sample (2.16 g/cc).

Accordingly, increasing the thermal conductivity of the insulating flake paper by replacing currently used mica flake with glass flake will provide for the opportunity to improve the overall thermal conductivity of a high voltage ground wall thereby resulting in increased power output and cost savings in electrical generation equipment.

Although the preferred embodiments of the invention have been shown and described, it should be understood that various modifications and changes may be resorted to without departing from the scope of the invention as disclosed and claimed herein.

1. An electrical insulation sheet having a thermal conductivity of from about 1.0 W/m° K. to about 1.4 W/m° K. comprising glass flake paper wherein said glass flake paper comprises D, C or E glass flake, or a mixture thereof having an average flake size of approximately at least 5μ thickness.

2. The electrical insulation sheet of claim 1, further comprising a reinforcing layer.

3. The electrical insulation sheet of claim 2, wherein the reinforcing later is a glass fabric or a polymeric film.

4. The electrical insulation sheet of claim 3, wherein the polymeric film is a polyester or polyimide film.

5. The electrical insulation sheet of claim 2, further comprising a binding resin.

6. The electrical insulation sheet of claim 1, wherein the glass flake has a median flake thickness of about 5μ.

7. The electrical insulation sheet of claim 1, wherein the glass flake has a median particle size of from about 200μ to about 400μ in diameter.

8. The electrical insulation sheet of claim 1, wherein the glass flake paper has a thickness from about 50μ to about 100μ.

9. The electrical insulation sheet of claim 1, wherein the glass flake insulation sheet has a density of at least about 1.60 g/cc.

10. A method of increasing the thermal conductivity of an electrical insulation sheet comprising mica as an insulating material, wherein the thermal conductivity of the insulation sheet is increased by replacing from >0% to 100% of the mica with a glass flake material selected from C, D or E glass flake.

11. A high voltage generator comprising a high voltage coil having an insulated ground wall, wherein an insulating layer on the insulated ground wall comprises a glass flake insulation sheet comprised of C, D or E glass flake or a mixture thereof.

12. The high voltage generator of claim 11, wherein the glass flake insulation sheet further comprises a reinforcing layer.

13. The high voltage generator of claim 12, wherein the reinforcing later is a glass fabric or a polymeric film.

14. The high voltage generator of claim 13, wherein the polymeric film is a polyester or polyimide film.

15. The high voltage generator of claim 12, wherein the glass flake insulation sheet further comprises a binding resin.

16. The high voltage generator of claim 11, wherein the glass flake has a median flake thickness of about 5μ.

17. The high voltage generator of claim 11, wherein the glass flake has a median particle size of from about 200μ to about 400μ in diameter.

18. The high voltage generator of claim 11, wherein the glass flake insulation sheet has a thickness from about 50μ to about 100μ.

19. The high voltage generator of claim 11, wherein the glass flake insulation sheet has a density of at least about 1.60 g/cc.
